(19) United States
(12) Patent Application Publication
(10) Pub. No.: US 2010/0304356 A1
(43) Pub. Date: Dec. 2, 2010

(54) ASSEMBLY AND A METHOD FOR IN SITU PROCESSING OF WASTE

(75) Inventor: Antonius Dorotheus Koens, Oldenzaal (NL)

Correspondence Address: FLIESLER MEYER LLP, 650 CALIFORNIA STREET, 14TH FLOOR, SAN FRANCISCO, CA, 94108, US

(73) Assignee: MPI-MANAGEMENT B.V., OLDENZAAL (NL)

(21) Appl. No.: 12/669,449

(22) PCT Filed: Jul. 18, 2008
(86) PCT No.: PCT/NL2008/050495

§ 371 Date: Jun. 16, 2010

(30) Foreign Application Priority Data
Jul. 18, 2007 (NL) 2000759

(51) Int. Cl. B09B 3/00

(52) U.S. Cl. 435/3; 435/286.6

(57) ABSTRACT

The invention relates to a device and a method for the in situ processing of waste, in particular for cleaning up a waste disposal site. The device comprises a sorting device with a set of processing devices connected downstream of said device. This set of processing devices comprises a fermenting device, a fluidized bed gasifier, and a pyrolysis device. Furthermore, the assembly comprises a control device for controlling and measuring the various material flows.

### BACKGROUND OF THE INVENTION

The invention relates to assembly and method for the in situ processing of waste.

In particular, the assembly and method is suitable for cleaning up a waste disposal site or former waste disposal site.

Such an approach to current and former waste disposal sites has not been known or applied until now.

Former waste disposal sites in particular are often situated in locations and places that are very suitable for other purposes, such as residential building or industrial development. However, because of the presence of the waste, nothing more can be done with the site.

### SUMMARY OF THE INVENTION

The object of the invention is to provide an assembly and a method for restoring to a usable state ground area that is currently or was formerly used as a waste disposal site.

A further object of the invention is to perform such restoration in an environmentally sound manner, without emission of harmful substances, and without such harmful substances reaching the environment.

To this end, the invention provides an assembly for the in situ processing of waste, in particular for cleaning up a waste disposal site, to form a series of output flows, comprising:

a sorting device for supplying and separating a waste flow into various partial flows, comprising a metals flow, a plastics flow, a glass flow, an organic flow and a chemical waste flow;

a set of processing devices, comprising:
a fermenting device for converting the organic flow into combustible biogases, provided with a fermenter inlet which is operationally connected to the sorting device, a biogas outlet which is connected to a biogas buffer, and a fermenter residual product outlet;
a fluidized bed gasifier for converting carbon-comprising materials into combustible gaseous products, comprising a gasifier inlet which is operationally connected to the sorting device, and a gasifier outlet;
a pyrolysis device for decomposing a flow of decomposable materials, such as the flow of chemical waste, into hydrocarbons and pyrolysis ash, comprising a pyrolysis inlet which is operationally connected to the sorting device, and a pyrolysis outlet which is connected to a pyrolysis buffer;

a generator with a steam turbine connected to it, operationally connected to a combustion chamber provided with a fuel inlet which is connected to the biogas buffer, the gasifier outlet and the pyrolysis buffer, and

a control device comprising a measuring device for measuring the composition of the various waste flows from the sorting device, the measuring device comprising a weighing device for weighing the waste flow, the various partial flows and the residual flows, and the measuring device being operationally connected to a computer device and a data storage device for logging the measured data from the measuring device, an input device for inputting proportion of desired output flows from the assembly, a first regulator at the fermenter inlet, a second regulator at the gasifier inlet, and a third regulator at the pyrolysis inlet, the computer being provided with software for calculating, from the measured data and the proportion of the desired output flows, flows of material to be supplied to the devices, and controlling of the first, second and third regulator for providing calculated material flows flowing to the processing devices.

By means of the devices and by continuous monitoring of the waste flow set in motion, it is possible to react immediately to components and substances present in the waste flow. Refuse dumps are often found to contain a high concentration of relatively valuable residual materials. By means of the control device, it is furthermore possible to control the end products in such a way that the financial return can be maximized. Moreover, continuous control of the processed flow is possible, also for a supervisor/authority having to supervise responsible processing.

The processing devices make it possible to vary the processing capacity and adapt it to a situation, in other words, inter alia, to vary the compositions and quantities of the various flows and the desired end products or proportion of end products.

Further embodiments of the assembly according to the invention are described in subclaims 2-9.

Subclaims 2-8 deal with interconnections in the assembly making it possible to use products obtained in one part of the assembly as fuel in another part of the assembly, and in particular under the control of the control device.

Claims 2 and 3 deal with the generation of electricity by means of those products usable as fuel. The electricity output here is greater than the electricity requirements of the assembly, so that electricity, even a great deal of electricity, can also be supplied to the national or another electric grid.

According to claim 9, one or more of the processing devices—in particular all processing devices—and/or the generator unit and/or the incinerators are made up of modules that can be disassembled and reassembled, which modules can be transported by road on a vehicle such as a low loader or truck. The assembly according to the invention is therefore easy to disassemble after the work has been carried out in situ, and is easy to move to another site, construct at that other site and use at that other site for the in situ processing of waste there. This is of great benefit particularly for cleaning up waste disposal sites.

The invention also relates to a method for processing waste, in particular for processing or cleaning up of a waste disposal site, comprising the steps:
Supplying a waste flow from a waste disposal site;

separating the waste flow into different flows of reusable material, such as glass, metal and plastic and a flow of residual material, such as a flow of organic material, a flow of carbon-containing material and a flow of chemical waste;
measuring parameters of the composition of the waste flow, of the flows of residual material and of the flows of reusable material, comprising the mass;
inputting the measured parameters into a control device;
inputting an end product demand or a proportion of end products into the control device;
calculating from the input end product demand or the proportion of end products and the measured parameters a first, second and third flow of residual material;
by means of control device, controlling the supply of the first flow of residual material to a biogas device, the supply of the second flow of residual material to a fluidized bed device, and the supply of the third flow of residual material to a pyrolysis device.

It should be clear that the various aspects mentioned in this patent application can be combined and can each be considered individually for a divisional patent application.

### BRIEF DESCRIPTION OF THE FIGURES

The appended figures show various embodiments of an assembly and a method according to the invention, in which:

FIG. 1 shows a chart of the various processing devices and flows between them;

FIG. 2 shows the chart of FIG. 1 with a control device and the control.

### DESCRIPTION OF EMBODIMENTS

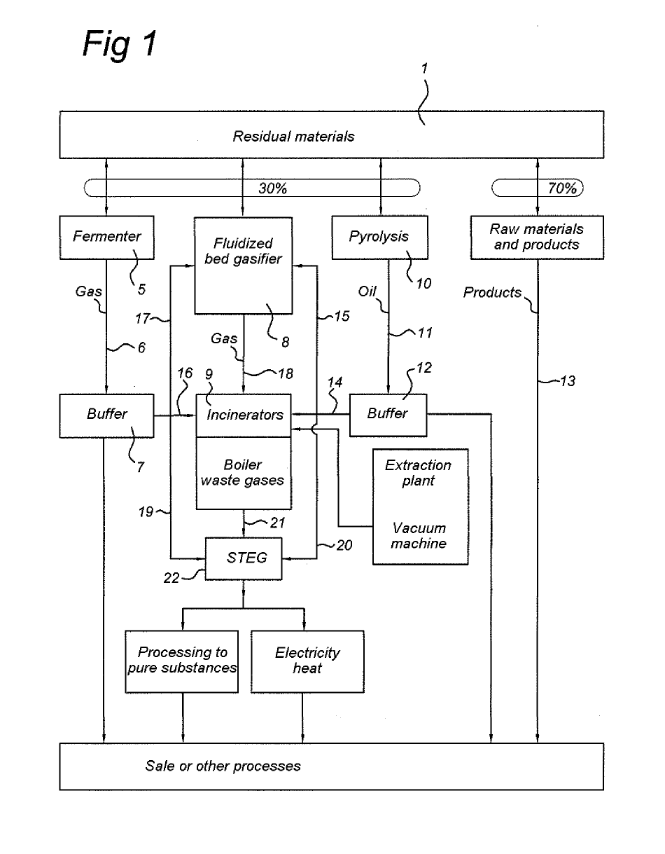

FIG. 1 shows an embodiment of an assembly for the in situ processing of waste or for cleaning up a waste disposal site according to one embodiment of the invention. The waste disposal site or the flow of waste is set in motion by means of, for example, an excavator or other devices which excavate a refuse dump and convert it into a flow of material which is fed to a sorting device 1.

The sorting device 1 can be composed of one or more of the following interconnected components, such as, for example, one or more: Rotamill excavator(s); shovel(s); shovel loader(s); dumper truck(s), such as the Volvo BM type, conveyor belts; Powerscreen GAOF screen(s); vibrating conveyor(s), for example one or more octagonal drum screens, one or more round drum screens, one or more flat vibrating screens; magnetic separator(s); wind shifter(s); air jet separator(s) (also referred to as airjets); low-pressure cold washer(s); low-pressure hot washer(s); high-pressure steam washer(s); high-pressure pulsating washer(s); alkaline washing machine(s); acid washing machine(s); neutralization washing machine(s); UV treatment unit(s); paper spike(s) (a standard component obtainable from, inter alia, Bollegraaf in Appingerdam, the Netherlands); ultrasonic cleaning unit(s); LI separator(s) (a special type of glass/metal separator); color separators for separating colored glass; CP Unit separator(s) (a plastics separating machine); high-pressure water cutter(s); shredder(s), such as high-speed shredder(s) and/or low-speed shredder(s).

These components divide the flow of materials into and convey them in various flows, including, for example, a flow of metal waste, a flow of plastics waste, a flow of glass waste, and a flow of mainly organic material. The various flows can be fed to various processing devices, which are shown in FIG. 1.

The flow of mainly organic material will usually be fed to a fermenter 5, where aerobic or anaerobic fermenting converts the organic material into biogas. The biogas flow is indicated by reference numeral 6. Said biogas flow will usually be stored in buffer 7.

A second flow of residual material is a flow that consists largely of carbon-containing materials. These carbon-containing materials are passed over a fluidized bed gasifier 8, where a large part of the material is converted into combustible gaseous product, which flow of gaseous product is indicated by reference numeral 18. This combustible gaseous product is fed to incinerators 9. The solid particles can be removed from the waste gases of the incinerators for processing to pure substances. Furthermore, the waste gases, in particular the heat that they contain, can be used for generating electricity.

Another flow of residual material is fed for processing to a pyrolysis device 10, where material with carbon can be converted into oily products, which flow is indicated by reference numeral 11, and which flow of oily material is stored in buffer 12.

As indicated by arrows 14 and 15, oily material stored in buffer 12 is reusable as a fuel for the fluidized bed gasifier 8 and/or the incinerators 9. As indicated by arrows 16 and 17, the biogases stored in buffer 7 are also reusable as a fuel for the fluidized bed gasifier 8 and/or the incinerators 9. Whether or not contents of one—and if so, which one—and/or both of these buffers are used as fuel for the fluidized bed gasifier 8 and/or the incinerators 9 will depend on the presence and the composition of the contents of the buffers. Mixing of fuel from the one buffer 7 with fuel from the other buffer 12 is also conceivable. The control device 40 yet to be discussed below is capable of controlling this mixing by means of measuring devices 41-53 and regulators 60-72.

The flow of reusable materials, including a metals flow and a glass waste flow, are separated further and can be offered as pelletized material for reuse. The plastic or substantially plastic containing material can be fed either to the fluidized bed gasifier or to the pyrolysis device, or it can be sorted and turned into scrap and supplied as a raw material and offered to producers. This flow is shown by reference numeral 13.

The assembly is furthermore provided with a generator unit 22. This generator unit comprises an electricity generator and a combustion chamber. The combustion chamber can form part of an internal combustion engine, but according to the invention it is in particular operationally connected to a steam turbine system, which is indicated in the drawing as STEG (Steam Electricity Generator). The generator unit 22 is fed with fuel obtained elsewhere in the assembly. For this purpose, the generator unit is connected by means of line 19 to the biogas buffer 7, by means of line 21 to the incinerator unit 9, and by means of line 20 to the pyrolysis buffer 12. By means of regulators 70, 71 and 72, the control device 40 to be discussed below is capable of regulating the fuel flows through the lines 19, 20, 21.

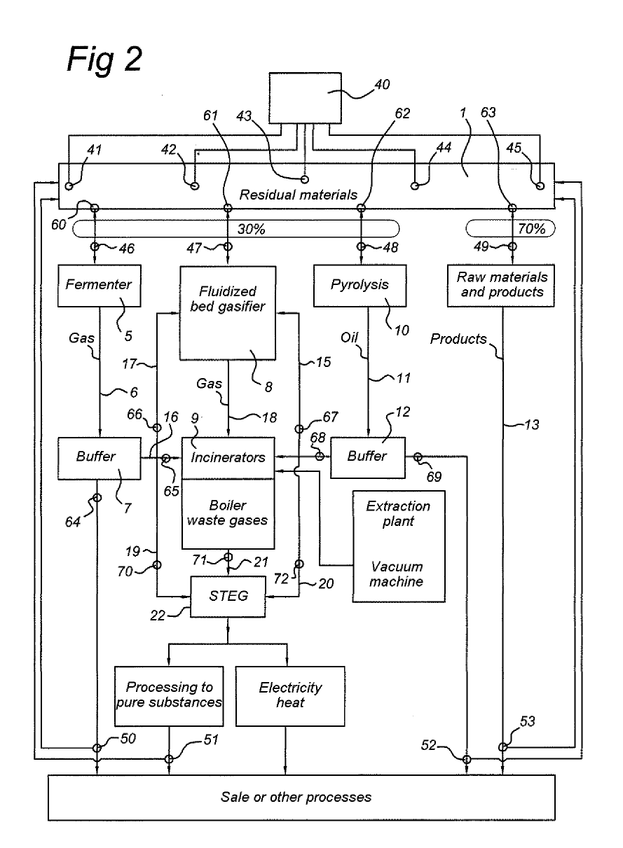

In FIG. 2 a control device 40 is added to the diagrammatic view of FIG. 1. The control device 40 is operationally connected to measuring devices 41-53. These measuring devices will in most cases comprise weighing devices. These weighing devices make it possible, inter alia, to produce records of the mass of the various flows.

The control device 40 is furthermore connected to regulators 60-72 to regulate the flows to the various devices. These regulators can be, for example, slides which divide the flows, or actuators which move or turn conveyor belts, so that they make the flow of material, for example from the fermenter, go fully or partially to the fluidized bed gasifier, or they can be valves which regulate the volume flow rate through a line.

It should be clear that the above description has been given to illustrate the functioning of preferred embodiments of the invention, and not to limit the scope of the invention. On the basis of the above explanation, many variations which fall within the spirit and scope of the present invention will be evident to a person skilled in the art

1-12. (canceled)

13. An assembly for the in situ processing of waste, in particular for cleaning up a waste disposal site, to form a series of output flows, comprising:
a sorting device for supplying and separating a waste flow into various partial flows, comprising a metals flow, a plastics flow, a glass flow, an organic flow and a chemical waste flow;
a set of processing devices, comprising:
a fermenting device for converting the organic flow into combustible biogases, provided with a fermenter inlet which is operationally connected to the sorting device, a biogas outlet which is connected to a biogas buffer, and a fermenter residual product outlet;
a fluidized bed gasifier for converting carbon-comprising materials into combustible gaseous products, comprising a gasifier inlet which is operationally connected to the sorting device, and a gasifier outlet;
a pyrolysis device for decomposing a flow of decomposable materials, such as the flow of chemical waste, into hydrocarbons and pyrolysis ash, comprising a pyrolysis inlet which is operationally connected to the sorting device and a pyrolysis outlet which is connected to a pyrolysis buffer;
a control device comprising a measuring device for measuring the composition of the various waste flows from the sorting device, the measuring device comprising a weighing device for weighing the waste flow, the various partial flows and the residual flows, and the measuring device being operationally connected to a computer device and a data storage device for logging the measured data from the measuring device, an input device for inputting proportion of desired output flows from the assembly, a first regulator at the fermenter inlet, a second regulator at the gasifier inlet, and a third regulator at the pyrolysis inlet, the computer being provided with software for calculating, from the measured data and the proportion of the desired output flows, flows of material to be supplied to the devices, and controlling of the first, second and third regulator for providing calculated material flows flowing to the processing devices.

14. The assembly as claimed in claim 13, characterized in that the assembly furthermore comprises a generator unit provided with electricity generator, a combustion chamber provided with a fuel inlet, and preferably a steam turbine operationally connected to the electricity generator and the combustion chamber, the fuel inlet of the combustion chamber being connected to the biogas buffer and/or the gasifier outlet and/or the pyrolysis buffer.

15. The assembly as claimed in claim 14, characterized in that the control device is operationally connected to regulators in order to control the fuel flow from the biogas buffer to the combustion chamber and/or from the gasifier outlet to the combustion chamber and/or from the pyrolysis buffer to the combustion chamber respectively.

16. The assembly as claimed in claim 13, characterized in that the biogas buffer is coupled to the fuel supply of the fluidized bed gasifier in order to supply fuel to the fluidized bed gasifier, and/or in that the pyrolysis buffer is coupled to the fuel supply of the fluidized bed gasifier in order to supply fuel to the fluidized bed gasifier.

17. The assembly as claimed in claim 16, characterized in that the control device is operationally connected to regulators in order to control the fuel flow from the biogas buffer to the fluidized bed gasifier, and/or from the pyrolysis buffer to the fluidized bed gasifier respectively.

18. The assembly as claimed in claim 13, characterized in that the gasifier outlet of the fluidized bed gasifier is connected to incinerators for burning combustible constituents in the flow guided through the gasifier outlet.

19. The assembly as claimed in claim 18, characterized in that the biogas buffer is coupled to the fuel supply of said incinerators in order to supply fuel to said incinerators and/or in that the pyrolysis buffer is coupled to the fuel supply of said incinerators in order to supply fuel to said incinerators.

20. The assembly as claimed in claim 19, characterized in that the control device is operationally connected to regulators in order to control the fuel flow from the biogas buffer to the incinerators and/or from the pyrolysis buffer to the incinerators respectively.

21. The assembly as claimed in claim 13, characterized in that one or more of the processing devices, in particular all processing devices and/or the generator unit and/or the incinerators are made up of modules that can be disassembled and reassembled, which modules can be transported by road on a vehicle such as a low loader or truck.

22. A method for processing waste, in particular for processing or cleaning up of a waste disposal site, comprising the steps:
supplying a waste flow from a waste disposal site;
separating the waste flow into different flows of reusable material, such as glass, metal and plastic and a flow of residual material, such as a flow of organic material, a flow of carbon-containing material and a flow of chemical waste;
measuring parameters of the composition of the waste flow, of the flows of residual material and of the flows of reusable material, comprising the mass;
inputting the measured parameters into a control device;
inputting an end product demand or a proportion of end products into the control device;
calculating from the input end product demand or the proportion of end products and the measured parameters a first, second and third flow of residual material;
by means of the control device, controlling the supply of the first flow of residual material to a biogas device, the supply of the second flow of residual material to a fluidized bed device, and the supply of the third flow of residual material to a pyrolysis device.
